(19) United States
(12) Patent Application Publication
(10) Pub. No.: US 2026/0352057 A1
(43) Pub. Date: Nov. 5, 2026

(54) ELECTRIC MACHINE WITH STATOR SEALING SLEEVE

(71) Applicant: Rolls-Royce plc, London (GB)

(72) Inventor: Adam J. HAWKINS, Derby (GB)

(73) Assignee: Rolls-Royce plc, London (GB)

(21) Appl. No.: 19/633,008

(22) Filed: Mar. 30, 2026

(30) Foreign Application Priority Data
May 1, 2025 (GB) 2506641.6

(51) Int. Cl. H02K 5/128; H02K 5/08; H02K 7/00; H02K 7/14

(52) U.S. Cl. CPC H02K 5/128; H02K 5/08; H02K 7/003; H02K 7/14

(57) ABSTRACT

The disclosure relates to an electric machine having a stator sealing sleeve for providing a seal between a rotor cavity and an external environment. In an example embodiment, an electric machine comprises: a housing; a stator mounted to the housing and defining a rotor cavity; a rotor rotatably mounted to the housing within the rotor cavity for rotation about a longitudinal axis, a rotor-stator gap defined between a radial outer surface of the rotor and a radial inner surface of the stator; and a stator sealing sleeve disposed within the rotor-stator gap and having first and second opposing ends sealed against the housing to provide a fluid seal between the rotor cavity and an external environment.

### CROSS REFERENCE TO RELATED APPLICATIONS

This specification is based upon and claims the benefit of priority from United Kingdom patent application GB 2506641.6 filed on May 1, 2025, the entire contents of which is incorporated herein by reference.

### BACKGROUND

### Technical Field

This disclosure relates to an electric machine having a stator sealing sleeve for providing a seal between a rotor cavity and an external environment.

### Description of the Related Art

Electric machines, which may operate as either motors or generators, comprise a stator and a rotor and operate to couple magnetic flux with rotary motion of the rotor relative to the stator. In an electric motor, a magnetic flux generated by electric currents flowing through the stator causes rotation of the rotor, while in an electric generator rotation of the rotor generates a magnetic flux to cause electric currents to flow in the stator. To maximise efficiency, a gap between the stator and the rotor should be as small as possible, while avoiding any possible contact during operation.

Electric motors are often used to power rotation in machinery such as pumps. Such pumps will have an operating fluid and will generally require seals to keep fluid out of the electric motor. Such seals are rarely perfect and will tend to have some leakage. Some operating fluids are more difficult to seal, especially with a dynamic shaft seal, meaning that the electric motor may need to tolerate being in contact with the operating fluid. While the rotor of the electric machine can generally be designed to be compatible with being in contact with a wide range of operating fluids, designing a stator to be also compatible may be more problematic, particularly for certain operating fluids such as hydrogen. A particular problem with hydrogen, as well as difficulty in providing seals, is that of hydrogen embrittlement or decrepitation, which can affect a range of different metallic and other materials and can result in material degradation during extended use.

### SUMMARY

According to the disclosure there is provided an electric machine comprising:
a housing;
a stator mounted to the housing and defining a rotor cavity;
a rotor rotatably mounted to the housing within the rotor cavity for rotation about a longitudinal axis, a rotor-stator gap defined between a radial outer surface of the rotor and a radial inner surface of the stator; and
a stator sealing sleeve disposed within the rotor-stator gap and having first and second opposing ends sealed against the housing to provide a fluid seal between the rotor cavity and an external environment.
The stator sealing sleeve may be formed of a fibre-reinforced composite comprising a matrix material and embedded reinforcing fibres.
The matrix material may comprise an epoxy resin.
The matrix material may be electrically insulating.
The embedded reinforcing fibres may comprise a mixture of carbon fibres and glass fibres. The carbon fibres may be aligned circumferentially around the stator sealing sleeve, for example at an angle of between around 70 and 85 degrees to the longitudinal axis.

The electric machine may comprise first and second sealing rings arranged to fluidly seal the respective first and second opposing ends of the stator sealing sleeve against the housing. The first and second sealing rings may be mounted around a radial outer surface of the stator sealing sleeve.

The stator sealing sleeve may have a first radial thickness along a first portion having an outer surface extending along the stator and a second radial thickness along a second portion between an end of the stator and the first end of the stator sealing sleeve. The second radial thickness may be greater than the first radial thickness. The second radial thickness may be between two and four times thicker than the first radial thickness.

The first radial thickness may be between around 0.75 mm and 1.25 mm, for example around 1 mm.

According to a second aspect of the disclosure there is provided a fluid pump comprising an electric machine according to the first aspect, the fluid pump comprising an impeller connected to a shaft of the rotor.

According to a second aspect of the disclosure there is provided a method of pumping an operating fluid using the fluid pump according to the second aspect, the method comprising providing an electric supply to the stator to drive the rotor and cause the impeller to pump the operating fluid. The operating fluid may be hydrogen. A temperature of the operating fluid may be below 25 K during operation of the fluid pump.

### BRIEF DESCRIPTION OF THE DRAWINGS

Embodiments will now be described by way of example only with reference to the accompanying drawings, in which:

FIG. 1 is a schematic cross-sectional drawing of an example electric machine for a hydrogen pump;

FIG. 2 is an illustration of a section of an example stator sealing sleeve supported by stator teeth when under an internal pressure; and

FIG. 3 is a schematic cross-sectional drawing of an example hydrogen pump assembly.

### DETAILED DESCRIPTION

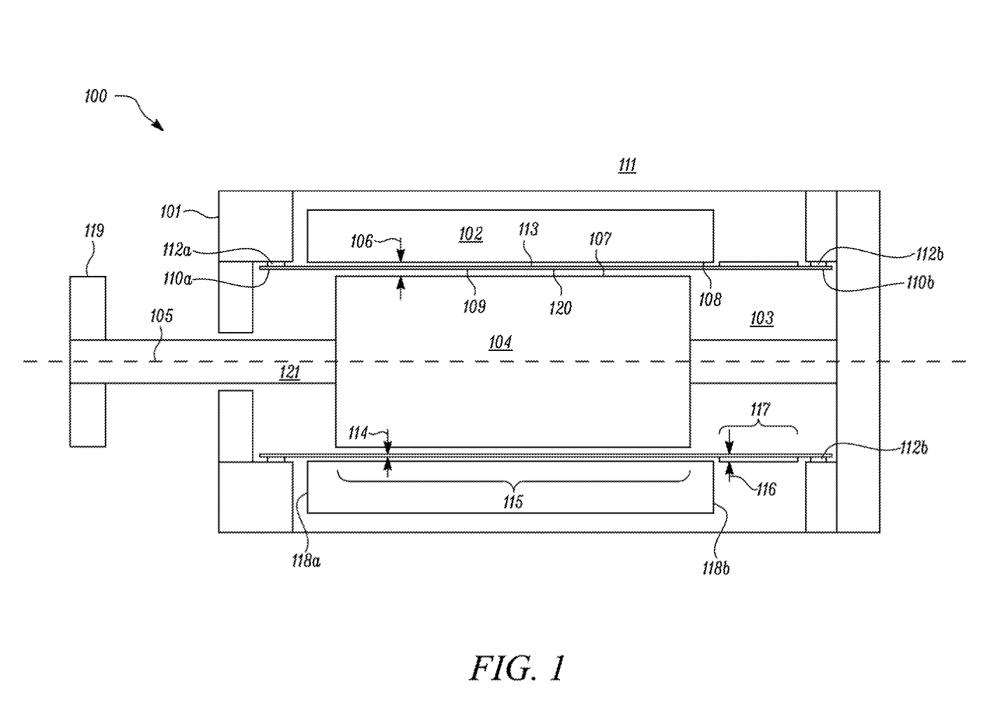

FIG. 1 is a schematic diagram illustrating an electric machine 100. The electric machine 100 comprises a housing 101 within which is provided a stator 102 and a rotor 104. The stator 102 is mounted to the housing 101 and defines a rotor cavity 103. The rotor 104 is rotatably mounted to the housing 101 within the rotor cavity 103 for rotation about a longitudinal axis 105. A rotor-stator gap 106 is defined between a radial outer surface 107 of the rotor 104 and a radial inner surface 108 of the stator 102.

A stator sealing sleeve 109 is disposed within the rotor-stator gap 106. The stator sealing sleeve 109 has first and second opposing ends 110a, 110b that are sealed against the housing 101 to provide a fluid seal between the rotor cavity 103 and an external environment 111, for example an external ambient atmosphere. The stator sealing sleeve 109 functions to prevent fluid within the rotor cavity from passing through to the stator 102 while leaving a sufficient gap between the radial outer surface 107 of the rotor and a radial inner surface 120 of the stator sealing sleeve 109 to allow the rotor 104 to freely rotate within the rotor cavity 103. The remaining gap between the radial inner surface 120 of the stator sealing sleeve 109 and the radial outer surface 107 of the rotor 104 may for example be around 0.25 mm.

The stator sealing sleeve 109 is in the form of a thin-walled tube that may be required to withstand a high-pressure difference between the operating fluid within the rotor cavity 103 and the external environment 111. The stator sealing sleeve 109 may therefore be formed of a fibre-reinforced composite having a matrix material with embedded reinforcing fibres. The matrix material may for example comprise an epoxy resin. For cryogenic applications such as for pumping hydrogen, the epoxy resin may be a suitable cryogenic epoxy resin, various types of which are available for aerospace and cryogenic applications. The epoxy resin should be robust against microcracking in cryogenic environments. To reduce electrical losses in the electric machine, the matrix material may be electrically insulating. For the stator sealing sleeve 109 to be mechanically strong enough to withstand high internal pressures, the embedded reinforcing fibres in the stator sealing sleeve 109 may comprise a mixture of carbon fibres and glass fibres. A carbon and glass fibre composite sleeve of around 1mm in thickness may be able to contain an internal pressure of more than 70 bar. An advantage of using glass fibres is that they are electrically insulating, so can be wound in any direction around the stator sealing sleeve 109. Carbon fibres, however, will be electrically conducting and may therefore be aligned circumferentially around the stator sealing sleeve. The fibres may be aligned at an angle close to 90 degrees to the longitudinal axis, for example at an angle of between around 70 and 85 degrees to the longitudinal axis 105, to reduce any electrical losses due to conduction within the carbon fibres during operation to reduce interference with performance of the electric machine 100, while still allowing the fibres to be wound continuously around the stator sealing sleeve along its length. Using a suitable fibre-reinforced composite material can allow the radial inner and outer surfaces 120, 113 of the stator sealing sleeve 109 to be machined to a good enough surface finish to allow the stator sealing sleeve 109 to seal against the housing 101.

To enable a seal to be provided, first and second sealing rings 112a, 112b may be arranged to fluidly seal the respective first and second opposing ends 110a, 110b of the stator sealing sleeve 109 against the housing 101. The first and second sealing rings 112a, 112b may be disposed around the radial outer surface 113 of the stator sealing sleeve 109. A region of controlled roughness may be provided on the stator sealing sleeve in contact with each of the first and second sealing rings 112a, 112b to enable an improved seal between the stator sealing sleeve surface and the sealing rings 112a, 112b. In a general aspect therefore, a surface roughness of a portion of the surface of the stator sealing sleeve 109 in contact with each of the first and second sealing rings 112a, 112b may be greater than a surface roughness of a remaining portion of the surface of the stator sealing sleeve 109. Each end of the stator sealing sleeve may for example have an Ra of around 0.3 micrometres, an Rmax of around 3.5 micrometres and an Rz of around 2.2 micrometres.

In the illustrated example in FIG. 1, the first and second seals 112a, 112b are mounted around the radial outer surface 113 of the stator sealing sleeve 109. This enables the seals 112a, 112b to provide an increased sealing capacity as the internal pressure within the rotor cavity increases. In alternative examples, the first and/or second seal 112a, 112b may be arranged to seal against the radial inner surface 120 of the stator sealing sleeve 109, which may enable an improved seal against the radial inner surface 120. Each of the seals 112a, 112b may be formed of a deformable polymeric material such as PTFE and may be spring energised. A spring energised seal may comprise an elastomeric shell and internal spring that energises the seal into position. In a particular example, a spring energised seal may comprise a PTFE seal in combination with an internal cobalt chrome nickel spring, both materials being robust against hydrogen embrittlement and capable of withstanding cryogenic environments.

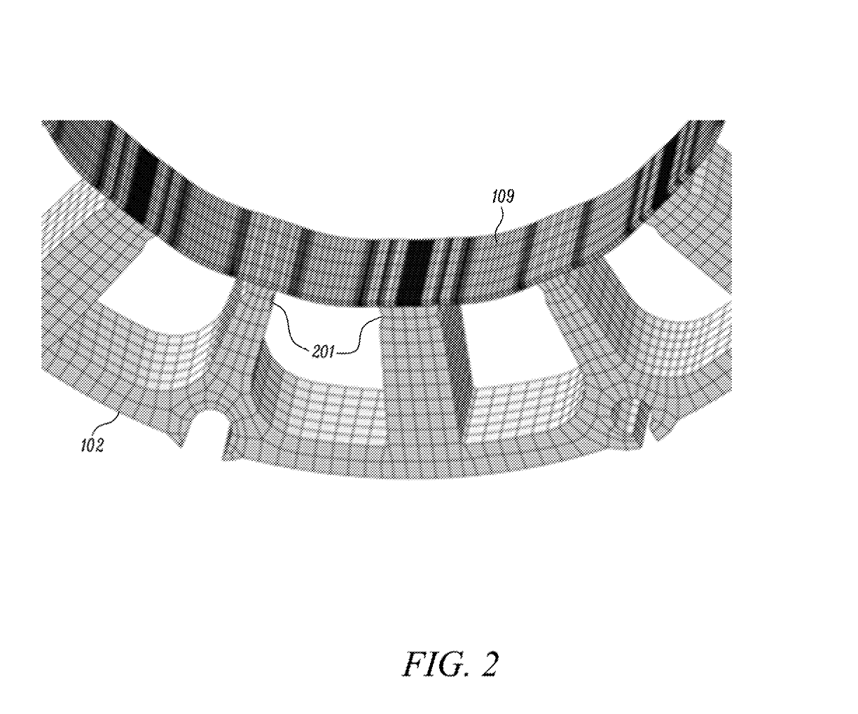

A first portion 115 of the stator sealing sleeve 109 extending between first and second opposing ends 118a, 118b of the stator and disposed between the stator 102 and the rotor 104 is required to have a first radial thickness 114 that is sufficient for the stator sealing sleeve 109 to withstand a required pressure difference between the rotor cavity 103 and the external environment 111. During operation, this first portion 115 of the stator sealing sleeve 109 can be supported by the radial inner surface 108 of the stator 102, enabling the stator sealing sleeve 109 to withstand a higher internal pressure without undue deformation. FIG. 2 illustrates an example output from a finite element model of a stator sealing sleeve 109 within a stator 102. An internal pressure causes sections of the stator sealing sleeve 109 to deform radially outwards between adjacent teeth 201 of the stator 102. The stator sealing sleeve 109 needs to be designed so that this deformation can be withstood without damage.

Outside of the rotor-stator gap 106, a second portion 117 between a second end 118b of the stator 102 the stator sealing sleeve 109 is not supported by the stator 102 and may therefore have a second radial thickness 116 greater than the first radial thickness 114. The second radial thickness 116 may for example be between around two and four times thicker than the first radial thickness 114. The second radial thickness 116 may be determined by the expected maximum internal pressure and by the distance between the second end 118b of the stator and the second end 110b of the stator sealing sleeve 109.

In a particular arrangement, the first radial thickness 114 may be between around 0.75 and 1.25 mm, for example around 1 mm. The second radial thickness 116 may be greater than or equal to the first radial thickness, and in particular arrangements may be around 2 mm or more, or between around 2 mm and 4 mm or between around 2 mm and 10 mm. The upper limit of the second radial thickness 116, unlike the first radial thickness 114 is not limited by the gap between the rotor 104 and stator 102. A greater second radial thickness 116 also makes the stator sealing sleeve 109 stronger in the area where the increased thickness does not affect the electrical machine 100 and makes the sleeve more robust against a potential stress concentration when the sleeve expands under pressure and the radial outer surface makes contact with the second end 118b of the stator 102.

A particular application for the electric machine 100 is to power a fluid pump. An impeller 119 is connected to a shaft 121 of the rotor 104 for the electric machine 100 to drive the fluid pump. Other components of the fluid pump are not illustrated in FIG. 1. An electric supply is provided to the stator 102 to drive the rotor 104 and cause the impeller 119 to pump the operating fluid. The operating fluid may be hydrogen, which may be in a liquid and/or gaseous state at cryogenic temperatures, for example at or below 25 K during operation of the fluid pump. In such applications, the matrix of the stator sealing sleeve 109 is formed of an electrically insulating cryogenic epoxy resin.

The stator sealing sleeve 109 may be manufactured by winding a mixture of glass and carbon fibres on a mandrel using a filament winding process, embedding the fibres in an epoxy resin matrix and curing the composite material in an autoclave. The sleeve may be manufactured with additional layers across its entire length and the outer diameter of the sleeve may be machined, for example by being ground on a mandrel to the required outer diameter and surface finish. The sleeve is then fitted with sealing rings 112a, 112b capable of sealing against liquid hydrogen on the outer diameter at opposing ends 110a, 110b of the stator sealing sleeve 109 before being assembled in the housing 101 of the electric machine 100. As mentioned above, in some examples a better seal may be possible against the radial inner surface of the sleeve than against the radial outer surface, which requires a machines finish. This results from the finish of the inner surface being taken from the mandrel around which the sleeve is formed.

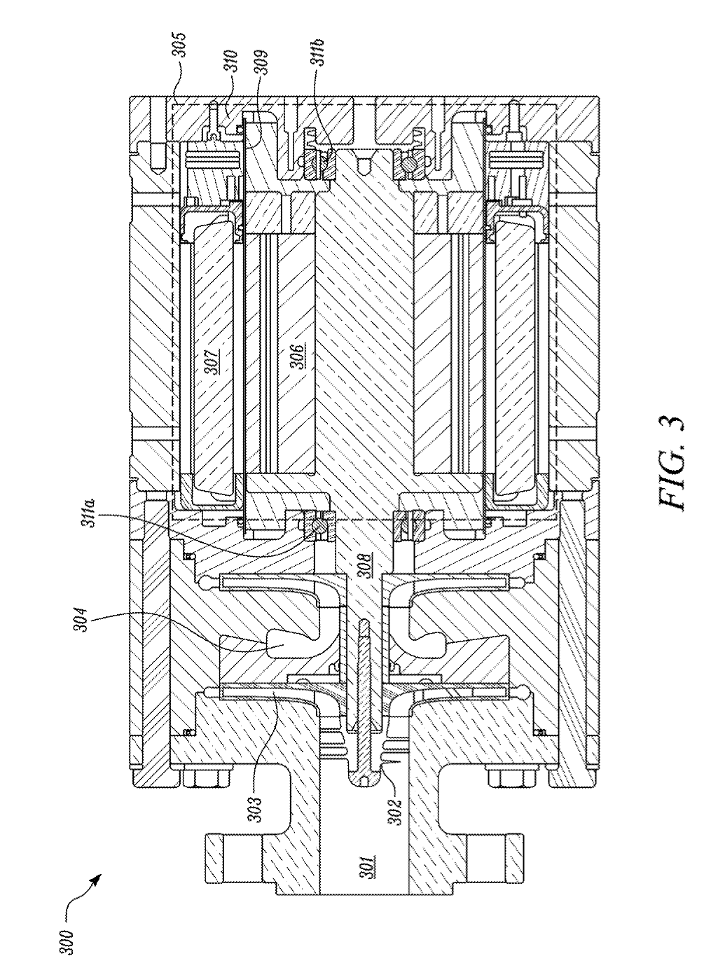

FIG. 3 illustrates in cross-section an example fluid pump assembly 300 for increasing the pressure of a hydrogen supply for a hydrogen-fuelled engine, such as a gas turbine engine. A hydrogen supply, which may be in liquid form or a mixture of liquid and gas, is provided to an inlet 301. This may be provided from a liquid hydrogen supply at a pressure of around 4 bar and at a temperature of around 25 K. The flow of hydrogen is stabilised by an inducer 302, which extends from a first stage impeller 303 into the inlet 301. The inducer 302 provides an initial pressure rise and is compatible with multi-phase flow. The first stage impeller 303 raises the pressure to around 8 bar. The hydrogen then passes to a second stage impeller 304 via external pipework (not shown), which raises the pressure further to around 20 bar. The hydrogen then exits the second stage impeller 304 via a diffuser (not shown). More than one such pump assembly 300 may be connected in series or parallel to provide increased pressure or flow of hydrogen.

The inducer 302, first stage impeller 303 and second stage impeller 304 are all driven by an electric machine 305. The electric machine 305 comprises a rotor 306 and stator 307. A rotor shaft 308 is connected to drive the inducer 302, first stage impeller 303 and second stage impeller 304. The rotor shaft 308 is mounted to the housing 310 with rolling bearings 311a, 311b at opposing ends of the rotor 306. The rotor 306 is contained within a stator sealing sleeve 309 that is sealed at opposing ends against the housing 310 of the electric machine 305. The construction and arrangement of the stator sealing sleeve 309 is similar to that described above. The rotor 306 is exposed to the incoming hydrogen fuel while the stator 307 is sealed against being exposed to hydrogen. Various components of the fluid pump assembly 300 may be manufactured from a material such as 316L stainless steel for resistance to hydrogen embrittlement.

It should be understood that the fluid pump assembly 300 is provided only as an example of a type of pump within which the stator sealing sleeve 309 may be incorporated. Other types of fluid pumps may alternatively be used. The stator sealing sleeve 309 may be incorporated into fluid pump designs for pumping fluids other than hydrogen, in which the rotor part of the electric machine is exposed to the fluid being pumped.

Various examples have been described, each of which comprise one or more combinations of features. It will be appreciated by those skilled in the art that, except where clearly mutually exclusive, any of the features may be employed separately or in combination with any other features and the invention extends to and includes all combinations and sub-combinations of one or more features described herein.

1. An electric machine comprising:
a housing;
a stator mounted to the housing and defining a rotor cavity;
a rotor rotatably mounted to the housing within the rotor cavity for rotation about a longitudinal axis, a rotor-stator gap defined between a radial outer surface of the rotor and a radial inner surface of the stator; and
a stator sealing sleeve disposed within the rotor-stator gap and having first and second opposing ends sealed against the housing to provide a fluid seal between the rotor cavity and an external environment.

2. The electric machine of claim 1, wherein the stator sealing sleeve is formed of a fibre-reinforced composite comprising a matrix material and embedded reinforcing fibres.

3. The electric machine of claim 2, wherein the matrix material comprises an epoxy resin.

4. The electric machine of claim 2, wherein the matrix material is electrically insulating.

5. The electric machine of claim 2, wherein the embedded reinforcing fibres comprise a mixture of carbon fibres and glass fibres.

6. The electric machine of claim 5, wherein the carbon fibres are aligned circumferentially around the stator sealing sleeve.

7. The electric machine of claim 6, wherein the carbon fibres are aligned at an angle of between around 70 and 85 degrees to the longitudinal axis.

8. The electric machine of claim 1, comprising first and second sealing rings arranged to fluidly seal the respective first and second opposing ends of the stator sealing sleeve against the housing.

9. The electric machine of claim 8, wherein the first and second sealing rings are mounted around a radial outer surface of the stator sealing sleeve.

10. The electric machine of claim 1, wherein the stator sealing sleeve has a first radial thickness along a first portion having an outer surface extending along the stator and a second radial thickness along a second portion between an end of the stator and the first end of the stator sealing sleeve.

11. The electric machine of claim 10, wherein the second radial thickness is greater than the first radial thickness.

12. The electric machine of claim 11, wherein the second radial thickness is between two and four times thicker than the first radial thickness.

13. The electric machine of claim 10, wherein the first radial thickness is between around 0.75 mm and 1.25 mm.

14. The electric machine of claim 10, wherein the first radial thickness is around 1 mm.

15. A fluid pump comprising an electric machine according to claim 1, the fluid pump comprising an impeller connected to a shaft of the rotor.

16. A method of pumping an operating fluid using the fluid pump according to claim 15, the method comprising providing an electric supply to the stator to drive the rotor and cause the impeller to pump the operating fluid.

17. The method of claim 16, wherein the operating fluid is hydrogen.

18. The method of claim 16, wherein a temperature of the operating fluid is below 25 K during operation of the fluid pump.
